(19) United States
(12) Patent Application Publication
(10) Pub. No.: US 2024/0024900 A1
(43) Pub. Date: Jan. 25, 2024

(54) COATING MACHINE

(71) Applicant: ABB Schweiz AG, Baden (CH)

(72) Inventor: Kuniharu Yamauchi, Tokyo (JP)

(21) Appl. No.: 18/355,744

(22) Filed: Jul. 20, 2023

(30) Foreign Application Priority Data
Jul. 20, 2022 (JP) 2022-115766

(51) Int. Cl. B05B 3/08; B05B 3/10

(52) U.S. Cl. CPC B05B 3/082; B05B 3/1035; B05B 3/1014

(57) ABSTRACT

Paint supply channel from paint chamber to rotary atomizing head of cartridge that forms the paint supply source is provided with first shearing member or second shearing member as a paint micronization means in order to promote micronization of the paint sprayed from rotary atomizing head. This first shearing member and second shearing member are equipped with a plurality of micropores for which the total area of the part that permits the distribution of paint is 1.53 mm² or less.

### TECHNICAL FIELD

The present invention relates to a coating machine that is provided with a rotary atomizing head-type coater.

### BACKGROUND ART

In general, coating machines to apply a coating such as on automobile bodies or the like may be attached to the tip of the arm part of equipment such as a painting robot. The coating machines is equipped with a rotary atomizing head-type coater to spray paint from the rotary atomizing head onto the object to be painted, a paint supply source to supply paint to the rotary atomizing head-type coater, and a paint supply channel from the paint supply source to the rotary atomizing head.

The rotary atomizing head-type coater has a rotary atomizing head to spray the paint on the tip of a hollow rotary axis that may be rotated by an air motor, and the structure enables the supply of paint from a feed tube inserted into the rotary axis towards the rotary atomizing head.

Here, in order to achieve stable and high quality painting, it is necessary to micronize the paint (paint particles) that may be sprayed from the rotary atomizing head. One means of micronizing the paint may be to increase the rotational speed of the rotary atomizing head. However, if the rotational speed of the rotary atomizing head is increased, the centrifugal force acting on the paint particles released from the rotary atomizing head will be increased. Therefore, it will be necessary to spray a large quantity of shaping air into the paint particles such that the paint particles released towards the surrounding area will be directed toward the object to be painted, making it difficult to control the spray pattern and increasing air consumption, which in turn increases running costs.

On the other hand, water-based paints are thixotropic and the viscosity will change depending on the condition, so the viscosity of these paints is unstable in comparison to solvent-based paints, making it difficult to stably micronize the paint. Therefore, it is known that coating machines can be used to enable stable micronization of paint by controlling (managing) the painting environment and painting method (Patent Literature 1).

### PRIOR ART LITERATURE

### Patent Literature

[Patent Literature 1] U.S. Pat. No. 4,781,975

### OUTLINE OF THE INVENTION

### Problem to be Solved by the Invention

The coating machine of Patent Document 1 finely manages the temperature within the paint booth and the time spent on painting work in order to control the viscosity of the paint. Therefore, this machine has the problem that, in order to micronize the paint and maintain paint quality, the modification of the equipment is costly and the control is labor-intensive.

The present invention was developed in light of the above-described problems with the prior art, and the aim of the present invention is to provide a coating machine that has been designed to allow for stable micronization of paint and improved paint quality by keeping the viscosity of the paint low.

### Means for Solving the Problem

According to the present invention, in a coating machine that is provided with a rotary atomizing head-type sprayer that has a rotary atomizing head to spray paint on the tip of a hollow rotary axis that may be rotated by an air motor and that will supply the paint from a feed tube inserted into the rotary axis towards the rotary atomizing head, a paint supply source that will supply the paint to said rotary atomizing head-type sprayer, and a paint supply path from the paint supply source to the rotary atomizing head, the paint supply path is provided with a paint micronization means to promote micronization of the paint sprayed from the rotary atomizing head.

### Effect of the Invention

According to the present invention, by keeping the viscosity of the paint low, the paint can be stably micronized, making it possible to improve the paint quality.

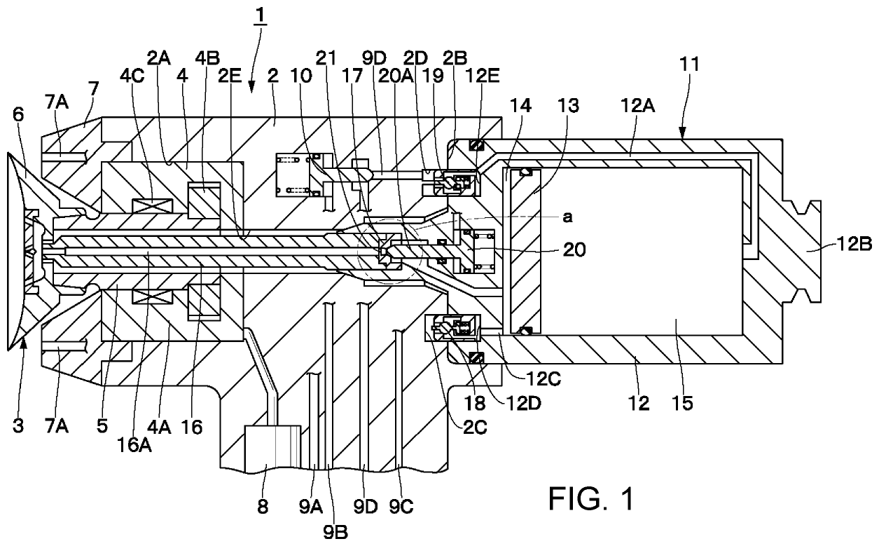

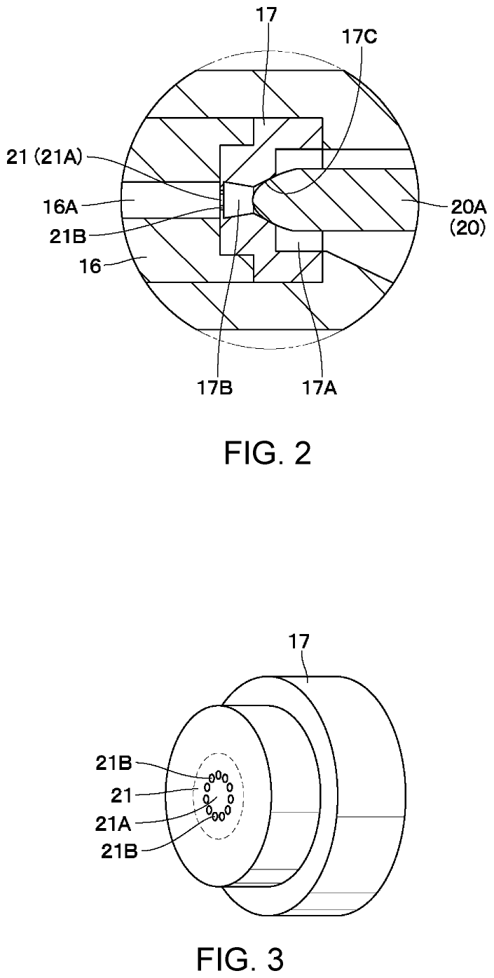

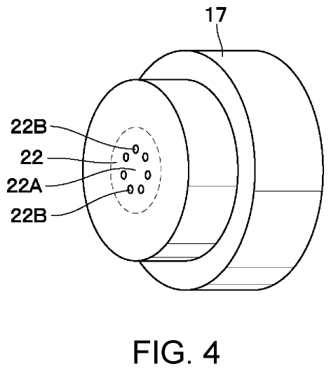

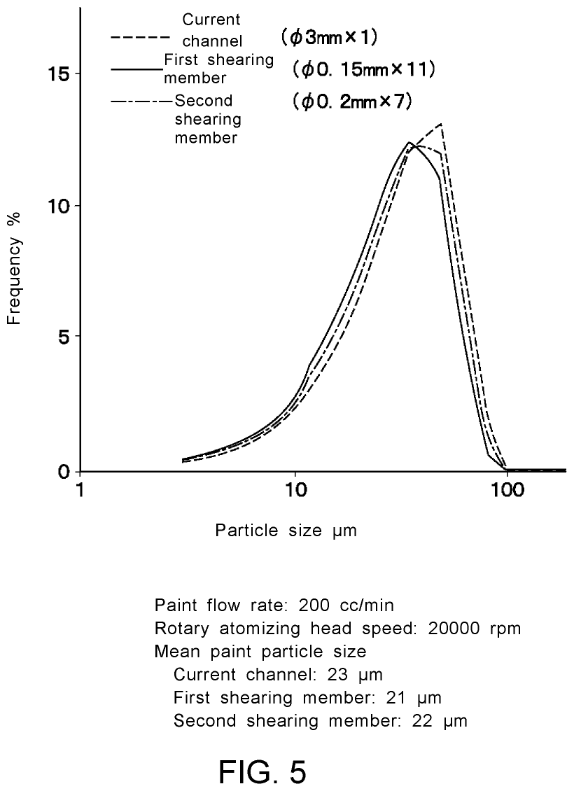

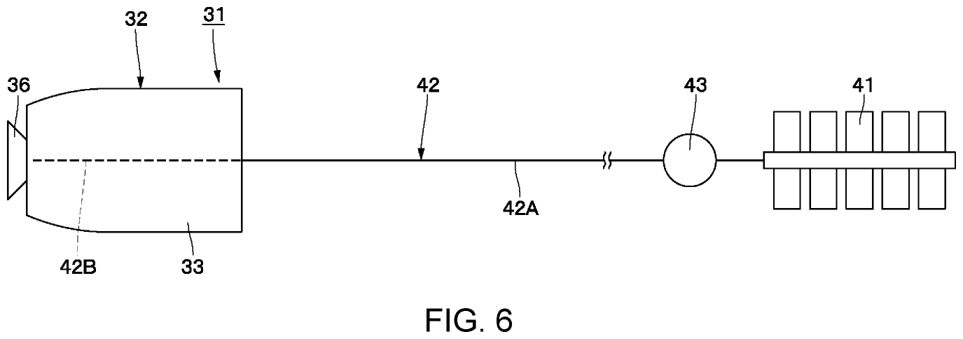

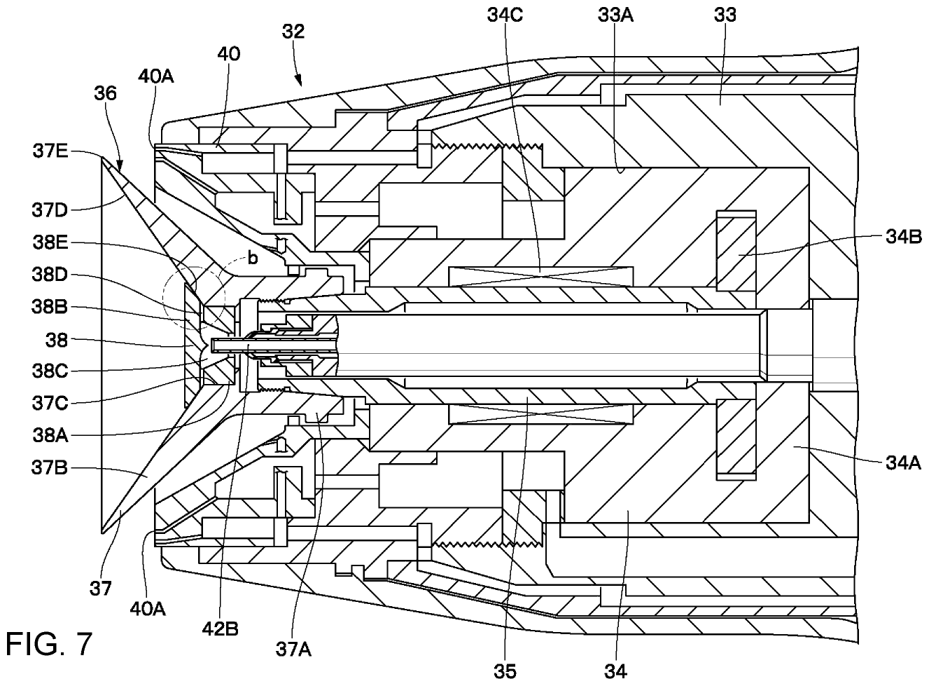

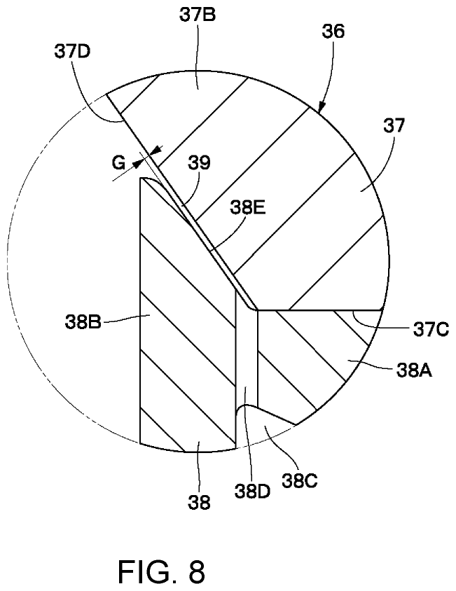

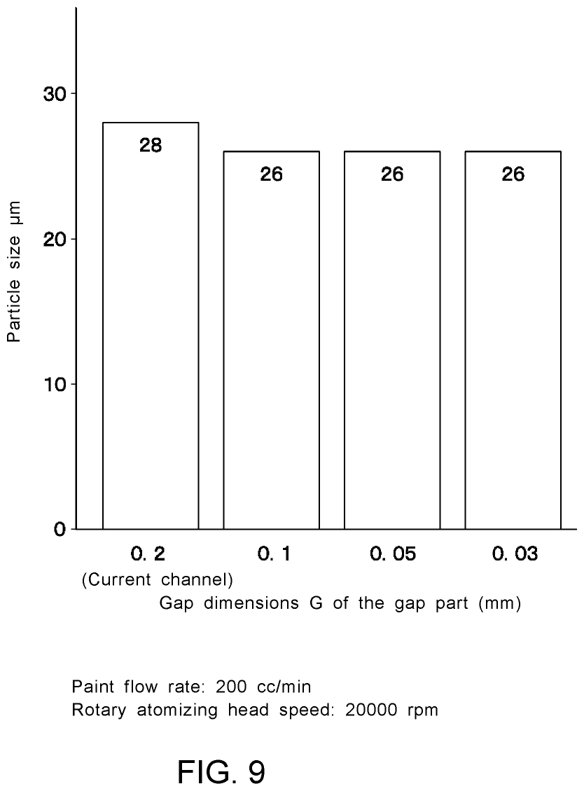

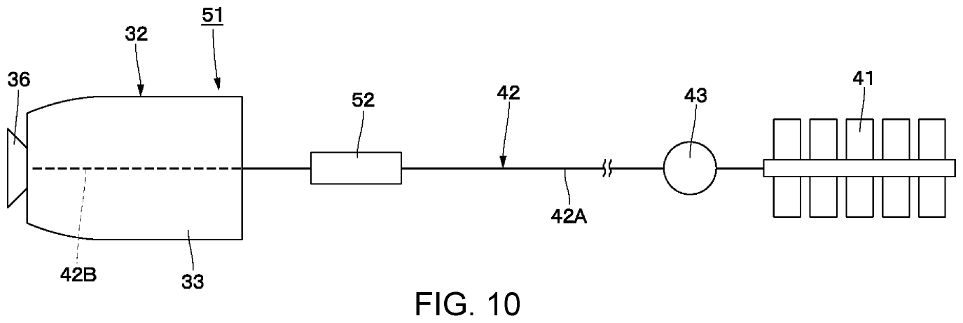

### BRIEF DESCRIPTION OF THE DRAWINGS

[FIG. 1] This is a cross-sectional view showing the coating machine according to the first example of embodiment of the present invention.

[FIG. 2] This is a cross-sectional view showing an enlargement of part a (shearing member) in FIG. 1.

[FIG. 3] This is a perspective view showing the first shearing member.

[FIG. 4] This is a perspective view showing the second shearing member.

[FIG. 5] This is an illustration (line graph) showing the relationship between the micropores and the particle size of the paint particles.

[FIG. 6] This is a general block diagram showing the coating machine according to the second example of embodiment of the present invention.

[FIG. 7] This is a cross-sectional view of the rotary atomizing head-type sprayer in FIG. 6.

[FIG. 8] This is a cross-sectional view showing an enlargement of part b (gap part) in FIG. 7.

[FIG. 9] This is an illustration (bar graph) showing the relationship between the gap dimensions of the gap part and the particle size of the paint particles.

[FIG. 10]This is a general block diagram showing the coating machine according to the third example of embodiment of the present invention.

### EXAMPLES OF EMBODIMENT OF THE INVENTION

The coating machine according to the example of embodiment of the present invention will be described in detail below based on the attached drawings.

First, FIGS. 1 through 5 show the first example of embodiment of the present invention. In FIG. 1, coating machine 1 is comprised of a cartridge-type electrostatic painting machine with cartridge 11 that is replaceably mounted as the paint supply source for rotary atomizing head-type sprayer 3. Coating machine 1 may be mounted, for example, on an operating arm (not shown in the figure) of a painting robot. Coating machine 1 is constructed to include housing 2, rotary atomizing head-type sprayer 3, cartridge 11, feed tube 16, and first shearing member 21 (or second shearing member 22).

Housing 2 of coating machine 1 may be mounted at the tip of the operating arm of the painting robot. On the front side of housing 2, sprayer mount 2A is formed in the shape of a bottomed cylinder, and on the back side of housing 2, cartridge mount 2B is formed in the shape of a bottomed cylinder. Further, at the bottom of cartridge mount 2B, there are mating hole 2C into which paint chamber on-off valve 18 of cartridge 11 may be mated, to be described later, and valve connection 2D that is connected to extrusion liquid seal valve 19.

In the center of housing 2, there is insertion hole 2E that extends in the axial direction. Feed tube 16 of cartridge 11, which will be described later, is inserted within insertion hole 2E. Also, the tip end of insertion hole 2E reaches to within rotary axis 5 that is provided in air motor 4, which will be described later.

Rotary atomizing head-type sprayer 3 is mounted to sprayer mounting section 2A of housing 2 (hereinafter to be referred to as sprayer 3). Sprayer 3 is constructed to have air motor 4 that is comprised of motor case 4A, air turbine 4B, and air bearing 4C, rotary axis 5 that is rotatably supported by air bearing 4C with air turbine 4B mounted in the rear, and rotary atomizing head 6 that performs centrifugal atomization to micronize the paint supplied from feed tube 16 as a result of mounting at the front end of rotary axis 5 and rotation by air motor 4. Air motor 4 may be controlled by, for example, detecting the rotational speed of air turbine 4B via an optical fiber (not shown in the figure).

Shaping air ring 7 is provided on the front side of housing 2 with rotary atomizing head 6 enclosed. Shaping air ring 7 expels the shaping air forward from a plurality of shaping air vents 7A. The shaping air will micronize the paint sprayed from rotary atomizing head 6 while ensuring that the paint pattern has the desired size and shape.

High voltage generator 8 is provided in housing 2. High voltage generator 8 may be constructed, for example, of a Cockcroft circuit, and it will increase the voltage supplied from a power supply (not shown in the figure) to −60 to −120 kV. The output side of high voltage generator 8 may then be electrically connected, for example, to air motor 4, and as a result, high voltage generator 8 will apply high voltage to rotary atomizing head 6 via rotary axis 5, directly charging the high voltage onto the paint supplied to rotary atomizing head 6.

A plurality of flow channels 9A, 9B, 9C, 9D are provided in housing 2 and are connected to a control air supply device or an extrusion liquid feed device (neither are shown in the figure). Of the plurality of flow channels 9A-9D, flow channels 9A, 9B, 9C shown as representative examples are used to distribute turbine air to control air motor 4, bearing air, brake air, shaping air for shaping the spray pattern of the paint, or pressurized air (pilot air) for opening and closing extrusion liquid valve 10 and trigger valve 20, and are connected to a control air source (not shown in the figure).

Also, of the plurality of flow channels 9A-9D, flow channel 9D will distribute the extrusion liquid for extruding the paint within cartridge 11. Flow path 9D is connected to an extrusion liquid feed device (not shown in the figure) at one end, while the other end is opened at the bottom of valve connection 2D formed in cartridge mount 2B of housing 2.

Extrusion liquid valve 10 is provided in housing 2. Extrusion liquid valve 10 always blocks flow channel 9D and blocks the distribution of the extrusion liquid to extrusion liquid chamber 15 of cartridge 11. Also, when extrusion liquid valve 10 is opened, extrusion liquid valve 10 permits the distribution of the extrusion liquid to extrusion liquid chamber 15 in order to supply and drain the extrusion liquid.

Cartridge 11 is detachably mounted to cartridge mount 2B of housing 2. On the other hand, cartridge 11 is detachably attached to a paint filling device (not shown in the figure) for a cartridge to perform filling and cleaning of paint. Cartridge 11 is constructed of tank 12, piston 13 and feed tube 16 as will be described later.

Tank 12 is formed as a cylindrical container with both axial ends blocked. Also, within tank 12, circular piston 13, which forms a partition, is displaceably fitted in the axial direction. Within tank 12, piston 13 separates front paint chamber 14 that may be filled with paint and rear extrusion liquid chamber 15, from which the extrusion liquid may be supplied and discharged.

Here, by pushing piston 13 with the extrusion liquid supplied to extrusion liquid chamber 15, tank 12 will shrink paint chamber 14, forming a paint supply source to supply the paint from paint chamber 14 towards the rotary atomizing head-type sprayer 3.

Tank 12 opens to the rear position of extrusion liquid chamber 15 to form extrusion liquid flow channel 12A. Also, gripping protrusion 12B is provided at the rear end of tank 12 to grip and transport cartridge 11. On the other hand, the front side of tank 12 is provided with paint flow channel 12C that is joined with paint chamber 14.

Further, on the front side of tank 12, there are valve mounting hole 12D for mounting the paint chamber on-off valve 18, which will be described later, and valve mounting hole 12E for mounting extrusion liquid seal valve 19. Here, when cartridge 11 is mounted to a paint filling device for the cartridge, paint flow channel 12C may be joined with the paint supply source and the cleaning solution source (neither are shown in the figure) on the cartridge paint filling device side, and paint chamber 14.

Feed tube 16 is provided, extending axially from the front central position of tank 12. The front side of feed tube 16 extends within insertion hole 2E, with its tip opening towards rotary atomizing head 6. Also, within feed tube 16, paint supply channel 16A is formed in a state in which it is joined with paint chamber 14 of tank 12. Paint supply channel 16A is a passage from tank 12, as the paint supply source, to rotary atomizing head 6. Further, feed tube 16 is provided with seat member 17, which will be described later, at a location midway through paint supply channel 16A.

Seat member 17 is provided in feed tube 16 at a location that is in front of trigger valve 20, which will be described later. As shown in FIGS. 2 and 3, valve seat member 17 is formed as a stepped cylindrical body with a large diameter on the rear side that forms the side of trigger valve 20. As a result, the inner circumferential side of valve seat member 17 has large diameter channel 17A on the back side and small diameter channel 17B on the front side. This large channel 17A and small channel 17B form part of paint supply channel 16A. The step between large diameter channel 17A and small diameter channel 17B is valve seat 17C, where valve body 20A of trigger valve 20 is detachably seated. Further, valve seat member 17 is provided with first shearing member 21 or second shearing member 22, as will be described later, at the front end of small diameter channel 17B.

Paint chamber on-off valve 18 is provided in valve mounting hole 12D located at the open end of paint flow channel 12C of tank 12. Paint chamber on-off valve 18 will close to block paint flow channel 12C when cartridge 11 has been isolated, when cartridge 11 is mounted to housing 2, or when cartridge 11 is only mounted to the cartridge paint filling device. On the other hand, paint chamber on-off valve 18 will join paint flow channel 12C with paint chamber 14 by opening the valve when cartridge 11 has been attached to the cartridge paint filling device to allow paint and cleaning liquid to be supplied to [paint chamber 14].

Extrusion liquid sealing valve 19 is provided in valve mounting hole 12E, positioned at the open end of extrusion liquid flow channel 12A of tank 12. Extrusion liquid sealing valve 19 functions as a check valve to block extrusion liquid flow channel 12A when cartridge 11 has been isolated. On the other hand, extrusion liquid sealing valve 19 will open to allow the extrusion liquid to flow when tank 12 is mounted to housing 2, and when [tank 12] is attached to the cartridge paint filling device.

Trigger valve 20 is provided at a site on the front of tank 12. Trigger valve 20 will open and close paint supply channel 16A in feed tube 16. Trigger valve 20 will open and close (joining or blocking) paint supply channel 16A by detaching or seating the axially displaceable valve body 20A to valve seat 17C of valve seat member 17.

Next, the configuration and effects of first shearing member 21 and second shearing member 22 that are characteristic parts of the first example of embodiment will be described in detail. First shearing member 21 and second shearing member 22 may be appropriately selected and used according to various paint conditions, such as type of paint (characteristics), the flow rate, the painting environment (temperature, humidity, etc.), or the shape of rotary atomizing head 6, etc.

First shearing member 21 as a shearing member is provided in a position to obstruct paint supply channel 16A in feed tube 16, and more specifically, it is provided in small diameter channel 17B of valve seat member 17 that constitutes part of paint supply channel 16A. First shearing member 21 constitutes a paint micronization means to promote the micronization of paint sprayed from rotary atomizing head 6.

First shearing member 21 is formed of circular blocking plate 21A that obstructs paint supply channel 16A of feed tube 16 and micropore 21B that penetrates blocking plate 21A in the direction of the plate thickness (the direction of the distribution of the paint). A plurality of micropore 21B, such as 11 [micropore 21B], may be arranged to form a circular shape. Also, micropore 21B has a smaller diameter than paint supply channel 16A that has an inner diameter dimension of approximately 3 mm (ø3 mm), and may, for example, have an inner diameter dimension of 0.15 mm (ø0.15 mm). As a result, due to the 11 units of micropore 21B, first shearing member 21 will have a total area of the part permitting the distribution of paint (flow channel) of 1.53 mm² or less, and more specifically, this area will be 0.19 mm².

Here, the water-based paint is thixotropic, so the viscosity may not be stable depending on the painting environment, etc. However, the water-based paint will pass through micropore 21B that has an inner diameter dimension of 0.15 mm, making it possible to continuously exert shear stress on this paint in order to stabilize the viscosity at a low value. Also, by providing 11 units of micropore 21B, first shearing member 21 will have a flow channel area of 0.19 mm², making it possible to distribute a sufficient amount of paint towards rotary atomizing head 6.

As shown in FIG. 4, second shearing member 22 as a shearing member may be used in place of first shearing member 21 according to changes in the painting environment, the object to be coated, and the paint. As is the case with first shearing member 21, second shearing member 22 constitutes a paint micronization means to promote the micronization of paint sprayed from rotary atomizing head 6. Second shearing member 22 is formed of blocking plate 22A and micropore 22B. A plurality of micropore 22B, such as 7 [micropore 22Bs], may be arranged to form a circular shape. Also, micropore 22B may have an inner diameter dimension of 0.2 mm (ø0.2 mm). As a result, second shearing member 22 will have a flow channel area of 0.22 mm², making it possible to distribute a sufficient amount of paint towards rotary atomizing head 6.

Next, the function of the micronization of the paint particles by first shearing member 21 and second shearing member 22 will be described using FIG. 5.

First, when applying a coating to an object to be painted such as an automobile or the like, the required coating film thickness may be set according to the area to be painted. As an example, the base process (a painting process intended to provide coloring) of the exterior coating for the current generic automobile requires a paint flow rate of about 200 cc/min in order to obtain a coating film of the established thickness. The paint flow rate is not limited to 200 cc/min.

Also, the rotational speed of rotary atomizing head 6 (air motor 4) may be set to a high rotational speed, such as for instance, 25,000 rpm or higher, such that even if painting is performed using the current channel (with an inner diameter dimension of 3 mm), the paint can be micronized to the predetermined particle size. In this way, if the rotational speed of rotary atomizing head 6 is set to a high value, it will be difficult to control the spray paint due to the increased centrifugal force, the occurrence of turbulence, etc., and the coating efficiency will decrease.

Therefore, in the paint test using coating machine 1 according to the first example of embodiment, the paint flow rate is set to 200 cc/min and the rotational speed of rotary atomizing head 6 (air motor 4) is set to 20,000 rpm. Also, as an example of a method of measuring the paint particles, a laser type measuring instrument (not shown in the figure) is placed between coating machine 1 and the coating in order to measure the particle size of the paint particles flying towards the object to be coated. In this case, the percentage of paint particles that could be measured by the measuring instrument is displayed as the frequency. In other words, the frequency can be expressed as the distribution ratio per particle size.

The paint supplied from tank 12 to rotary atomizing head 6 through paint supply channel 16A is continuously subjected to shear stress by first shearing member 21 (micropore 21B) or second shearing member 22 (micropore 22B) as it passes through valve seat member 17. As a result, the viscosity of thixotropic water-based paint will decrease, making it possible to supply the paint to rotary atomizing head 6 in this stable state of reduced viscosity. Paints with low viscosity are easily micronized even at low rotational speeds, making it possible to reduce the particle size of the paint particles.

More specifically, when looking at the line graph shown in FIG. 5, the measured values for the particle size during the paint test at a frequency of 5 to 10% will be for “first shearing member 21—second shearing member 22—current channel” in sequence from the smaller particle diameter. The average value for the specific measurements of particle size is 21 μm for first shearing member 21, 22 μm for second shearing member 22, and 23 μm for the current channel. In this way, first shearing member 21 can reduce the smaller particle size by as much as 2 μm more than the current channel. In this case, depending on the painting conditions, reducing the particle size by 2 μm allows the rotational speed of rotary atomizing head 6 (air motor 4) to be reduced by about 5000 rpm. In other words, by using first shearing member 21 and second shearing member 22, it will be possible to suppress the centrifugal force and turbulence, making it easy to perform control of the paint being sprayed.

By providing 11 units of micropore 21 B of first shearing member 21 with an inner diameter dimension of 0.15 mm, the overall flow channel area will be 0.19 mm². Also, by providing 7 units of micropore 22B of second shearing member 22 with an inner diameter dimension of 0.2 mm, the overall flow channel area will be 0.22 mm². In the present example of embodiment, the inner diameter dimension and number of micropores haven been established under various conditions, and as long as the total area of the part allowing the distribution of paint is within the range of 1.53 mm² or less, the present invention is not limited to the combinations described above. Further, if the total area of the micropores is the same, using a small inner diameter dimension and using a larger number of micropores will make it possible to more efficiently apply shear stress onto the paint.

Coating machine 1 according to the first example of embodiment has the structure as described above. Next, the operations when painting water-based paint onto the object to be coated using coating machine 1 will be described.

When performing painting, cartridge 11, of which paint chamber 14 has been filled with water-based paint, is mounted to housing 2. At that time, feed tube 16 is inserted into the insertion hole 2E and rotary axis 5, and tank 12 is attached to cartridge mount 2B. With cartridge 11 installed in housing 2, compressed air is supplied to air turbine 4B of air motor 4 to rotate rotary axis 5 and rotary atomizing head 6 together with air turbine 4B at high speed. Also, high voltage is applied to feed tube 16 from high voltage generator 8 via air motor 4 and rotary axis 5.

Next, trigger valve 20 is opened, while at the same time, extrusion liquid valve 10 is opened to supply the extrusion liquid to extrusion liquid chamber 15 of cartridge 11 through flow channel 9D and extrusion liquid flow channel 12A. As a result, the paint in paint chamber 14 will be pushed into piston 13 and fed through paint supply channel 16A to rotary atomizing head 6. Rotary atomizing head 6 micronizes and sprays the paint supplied from feed tube 16. Shaping air ring 7 also blows shaping air towards the paint particles sprayed from rotary atomizing head 6 in order to send the pain particles toward the object to be coated while shaping the paint particles into the desired spray pattern.

Here, in order to micronize the paint, or in other words, in order to reduce the particle size of the paint particles, it is necessary to precisely control the viscosity of the paint. However, in the case of water-based paints with unstable viscosity, the temperature in the paint booth and the time spent on the painting work must be carefully managed, necessitating not only costs required in changing the equipment, but also necessitating labor in performing this control.

However, according to this example of embodiment, paint supply channel 16A from paint chamber 14 to rotary atomizing head 6 of paint supply source cartridge 11 is provided with first shearing member 21 or second shearing member 22 as a paint micronization means in order to promote micronization of the paint sprayed from rotary atomizing head 6.

First shearing member 21 and second shearing member 22 are provided in a position to obstruct paint supply channel 16A within feed tube 16, and there is a plurality of micropores 21B and 22B ensuring that the total area of the part allowing the paint to be distributed is 1.53 mm² or less. As a result, it will be possible to reduce the viscosity of the paint that flows through paint supply channel 16A as a result of the application of shear stress by micropores 21B and 22B.

Therefore, by reducing the viscosity of the paint supplied to rotary atomizing head 6 by first shearing member 21 or second shearing member 22, it will be possible to promote the thinning and micronization of the paint, and the particle size of the paint particles sprayed from rotary atomizing head 6 can be stably reduced. As a result, it will be possible to improve the painting quality when coating machine 1 applies the paint to the object to be coated.

Also, because the paint can be micronized without increasing the rotational speed of rotary atomizing head 6, the centrifugal force acting on the paint particles released from rotary atomizing head 6 can be reduced to improve the coating efficiency. Further, because it will be possible to reduce the amount of shaping air that is emitted, the spray pattern can be easily controlled, and the amount of compressed air consumed can be reduced in order to reduce running costs.

Next, FIGS. 6 through 9 show the second example of embodiment of the present invention. The second example of embodiment is characterized by the fact that the rotary atomizing head is mounted at the tip end of the rotary axis, and there is a cup part that forms the extended paint surface with the front surface expanded forward, and a hub part that is provided inside the cup part and that is equipped with an opposing surface that forms a gap part circumferentially with the extended paint surface, wherein the paint micronization means has a gap dimension between the extended paint surface and the opposing surface of 0.2 mm or less for the gap part.

In FIG. 6, coating machine 31 according to the second example of embodiment will supply the paint from color switching valve device 41 that forms the paint supply source for rotary atomizing head-type sprayer 32. Coating machine 31 is constructed of rotary atomizing head-type sprayer 32, color switching valve device 41, and paint supply channel 42, which will be described later.

According to the second example of embodiment, rotary atomizing head-type sprayer 32 (hereinafter referred to as sprayer 32) may be mounted, for example, at the tip of an arm (not shown in the figure) of a painting robot. As shown in FIG. 7, sprayer 32 is constructed of housing 33, air motor 34, rotary axis 35, and rotary atomizing head 36, which will be described later.

The back side of housing 33 may be mounted at the tip of the operating arm of the painting robot. The inner circumferential side of housing 33 is motor housing 33A with an opening on the front side. Shaping air ring 40, which will be described later, is mounted on the front side of housing 33 such that it covers the front side of motor housing 33A.

Air motor 34 is provided in motor housing 33A of housing 33. Air motor 34 is powered by compressed air, and it will cause rotary axis 35 and rotary atomizing head 36, which will be described later, to rotate at high speed. Air motor 34 is constructed of motor case 34A, air turbine 34B, and air bearing 34C.

Rotary axis 35 is formed as a hollow cylinder that is rotatably supported by motor case 34A of air motor 34. Rotary axis 35 is mounted integrally in the center of air turbine 34B, with the front end protruding towards the front side from motor case 34A.

Rotary atomizing head 36 is mounted at the front end of rotary axis 35, and may be rotated at high speed together with rotary axis 35 by air motor 34. As a result, rotary atomizing head 36 will spray the paint, etc., that may be supplied from feed tube 42B.

Rotary atomizing head 36 is constructed of atomizing head body 37, hub part 38, and gap part 39, which will be described later.

Atomizing head body 37 is formed in a cup shape with the overall shape extending towards the front side. Atomizing head body 37 includes cylindrical mount 37A that is located on the rear side and mounted to the tip of rotary axis 35, and a cup part 37B that is expanded from the front part of mount 37A towards the front side. Also, bottomed hub mounting recess 37C is formed in the center of cup part 37B. Further, the front surface of cup part 37B forms tapered extended paint surface 37D that has been expanded forward, and the tip (front end) of extended paint surface 37D forms discharge edge 37E that releases the thinned paint as paint particles on extended paint surface 37D.

Hub part 38 is provided inside cup part 37B of atomizing head body 37. Hub part 38 is comprised of mating tube part 38A that is positioned on the rear side and fitted within hub mounting recess 37C, disc part 38B that is provided on the front side of mating tube part 38A, paint pool 38C that is enclosed within mating tube part 38A and disc part 38B, and discharge hole 38D that is positioned between mating tube part 38A and disc part 38B and that extends in the radial direction through and from paint pool 38C. Also, the outer circumferential surface of disc part 38B forms opposing surface 38E that faces extended paint surface 37D of atomizing head body 37. Opposing surface 38E consists of a tapered surface having a uniform small gap with extended paint surface 37D, and the gap between extended paint surface 37D and opposing surface 38E forms gap part 39, which will be described later.

As shown in FIG. 8, gap part 39 is provided circumferentially between extended paint surface 37D of atomizing head body 37 and opposing surface 38E of hub part 38. Gap part 39 constitutes a paint micronization means to promote the micronization of the paint that may be sprayed from rotary atomizing head 36. Gap part 39 has gap dimension G between extended paint surface 37D and opposing surface 38E that has been set to 0.2 mm or less. The lower limit of gap dimension G of gap part 39 may be set to 0.03 mm or more.

The paint that may be supplied from color switching valve device 41, which will be described later, through paint supply channel 42 to rotary atomizing head 36 will be continuously subjected to shear stress by gap part 39 as it passes between atomizing head body 37 and hub part 38. As a result, the viscosity of thixotropic water-based paint will decrease, making it possible to supply the paint to rotary atomizing head 36 in this stable state of reduced viscosity. Paints with low viscosity are easily micronized even at low rotational speeds, making it possible to reduce the particle size of the paint particles.

Shaping air ring 40 is provided on the front side of housing 33 with rotary atomizing head 36 enclosed. Shaping air ring 40 expels the shaping air forward from a plurality of shaping air vents 40A. The shaping air will micronize the paint sprayed from discharge edge 37E of rotary atomizing head 36 while ensuring that the paint pattern has the desired size and shape.

As shown in FIG. 6, the color switching valve device 41 constitutes the paint supply source that supplies the paint to sprayer 32. The color switching valve device 41 supplies a fluid selected from amongst a plurality of paints, air as a cleaning fluid, and thinner, to rotary atomizing head 36 via paint supply channel 42.

Paint supply channel 42 is a passage (pipe) from color switching valve device 41 to rotary atomizing head 36. Paint supply channel 42 is constructed to include paint piping 42A and feed tube 42B. Paint piping 42A is provided between color switching valve device 41 and sprayer 32. As shown in FIG. 7, feed tube 42B is connected to paint piping 42A at one end, and the other end extends forward within rotary axis 35, protruding into rotary atomizing head 36.

Paint pump 43 is provided in paint piping 42A of paint supply channel 42. Paint pump 43 consists of a positive displacement pump, such as for example, a gear pump or rotary pump, etc., in order to supply a fixed quantity of paint or cleaning fluid as selected by color switching valve device 41 to sprayer 32 (rotary atomizing head 36).

Next, FIG. 9 shall be used to describe the function of the micronization of paint particles by gap part 39.

In the paint test shown in FIG. 9, for example, a laser-type measuring instrument (not shown in the figure) is placed between coating machine 31 and the coating in order to measure the particle size of the paint particles flying towards the object to be coated, as was the case in the paint test in the first example of embodiment.

The painting conditions in the paint test include a paint flow rate of 200 cc/min, and a rotary atomizing head 36 (air motor 34) speed of 20,000 rpm. Further, gap dimension G of gap part 39 may be set to the current gap dimension of 0.2 mm, or the gap dimensions for micronization of the paint particles of 0.1 mm, 0.05 mm, and 0.03 mm in order to enable comparison of the particle diameters.

The paint selected by color switching valve device 41 may be supplied to rotary atomizing head 36 of sprayer 32 through paint supply channel 42, at which point it may be sprayed through gap part 39. At that time, if gap dimension G of gap part 39 is the current 0.2 mm, the particle size of the paint particles will remain at 28 μm there will be insufficient action of shear stress on the paint.

On the other hand, if gap dimension G of gap part 39 is set to 0.1 mm, 0.05 mm, and 0.03 mm, it will be possible to ensure the continuous action of sufficient shear stress on the paint. As a result, the viscosity of thixotropic water-based paint will decrease, making it possible to spray the paint from discharge edge 37E of atomizing head body 37 in this stable state of reduced viscosity. Paints with low viscosity are easily micronized even at low rotational speeds, making it possible to reduce the particle size of the paint particles down to 26 μm. Further, by reducing the particle size of the paint particles by 2 μm, it will be possible to reduce the rotational speed of rotary atomizing head 36 (air motor 34) by approximately 5000 rpm. In other words, by setting gap dimension G of gap part 39 to 0.03 mm or more, or less than 0.2 mm, it will be possible to reduce centrifugal force and turbulence, making it easy to control the paint being sprayed.

In this way, according to the second example of embodiment that has been constructed in this way, rotary atomizing head 36 is comprised of cup part 37B that is mounted at the tip end of rotary axis 35 and that has extended paint surface 37D of which the front surface is extended towards the front, and hub part 38 that is provided inside cup part 37B and that has opposing surface 38E that forms gap part 39 with extended paint surface 37D throughout the entire circumference. Further, the paint micronization means forms gap part with a gap dimension G between extended paint surface 37D and opposing surface 38E of less than 0.2 mm. As a result, by reducing the viscosity of the paint supplied to discharge edge 37E of atomizing head body 37 that constitutes rotary atomizing head 36 by gap part 39 (0.03 mm or more, or less than 0.2 mm), it will be possible to stably reduce the particle size of the paint particles that may be sprayed from rotary atomizing head 36. As a result, it will be possible to improve the painting quality when coating machine 31 applies the paint to the object to be coated.

Next, FIG. 10 shows the third example of embodiment of the present invention. The third example of embodiment is characterized by the fact that the paint micronization means is a mesh-shaped micronization member with a pore size of 20 μm or less that has been provided in the paint supply channel. In the third example of embodiment, the same symbols shall be attached to the same components as in the second example of embodiment that was described above, and the description of these components shall be omitted.

In FIG. 10, micronization member 52 of coating machine 51 constitutes the paint micronization means. Micronization member 52 is provided in the middle of the paint piping 42A of paint supply channel 42. More specifically, micronization member 52 is arranged close to sprayer 32 of paint piping 42A such that the paint, of which the viscosity has been reduced, can reach rotary atomizing head 36. Micronization member 52 is equipped with a mesh-shaped element (not shown in the figure) having a pore size of 20 pm or less. More specifically, an element with a pore size of 10 to 20 μm may be used.

As a result, shear stress will continuously act on the paint supplied from color switching valve device 41 through paint supply channel 42 to rotary atomizing head 36 as it passes through micronization member 52. As a result, the viscosity of thixotropic water-based paint will decrease, making it possible to supply the paint to rotary atomizing head 36 in this stable state of reduced viscosity. Paints with low viscosity are easily micronized even at low rotational speeds, making it possible to reduce the particle size of the paint particles.

In this way, according to the third example of embodiment that is constructed in this way, the paint micronization means is mesh-shaped micronization member 52 that has a pore size of 20 μm or less and that has been provided in paint piping 42A of paint supply channel 42. As a result, by using micronization member 52 to decrease the viscosity of the paint supplied to rotary atomizing head 36, it will be possible to stably reduce the particle size of the paint particles that may be sprayed from rotary atomizing head 36. As a result, it will be possible to improve the painting quality when coating machine 51 applies the paint to the object to be coated.

The first example of embodiment described an example in which coating machine 1 that is equipped with rotary atomizing head-type sprayer 3 was provided with first shearing member 21 and second shearing member 22 in order to promote paint micronization. However, the present invention may be configured to provide shearing members to other coating machines such as those equipped with inkjet sprayers or air atomizing sprayers, etc. This configuration may also be applied to the second and third examples of embodiment.

### EXPLANATION OF REFERENCES

1, 31, 51 Coating machine
3, 32 Rotary atomizing head-type sprayer
4, 34 Air motor
5, 35 Rotary axis
6, 36 Rotary atomizing head
11 Cartridge
12 Tank (paint supply source)
16, 42B Feed tube
16A, 42 Paint supply channel
21 First shearing member (paint micronization means)
21B, 22B Micropore
22 Second shearing member (paint micronization means)
37B Cup part
37D Extended paint surface
38 Hub part
38E Opposing surface
39 Gap part (paint micronization means)
41 Color switching valve device (paint supply source)
42A Paint piping
52 Micronization member (paint micronization means)
G Gap dimension of the gap part

1. A coating machine that is characterized by the fact that it is equipped with a rotary atomizing head-type sprayer having a rotary atomizing head to spray paint on the tip of a hollow rotary axis that may be rotated by an air motor in order to supply paint from a feed tube inserted into the rotary axis toward the rotary atomizing head,
a paint supply source to supply the paint for the rotary atomizing head-type sprayer,
and a paint supply channel from the paint supply source to the rotary atomizing head, wherein
said paint supply channel is provided with a paint micronization means to promote the micronization of the paint that may be sprayed from the rotary atomizing head.

2. The coating machine described in claim 1, wherein
said paint micronization means is provided at a position to obstruct the paint supply channel in the feed tube, and is a shearing member that is equipped with a plurality of micropores for which the total area of the part that allows for distribution of the paint is 1.53 mm² or less.

3. The coating machine described in claim 1, wherein
the rotary atomizing head is constructed of a cup part that is mounted at the tip end of said rotary axis and that has an extended paint surface with a front surface that extends toward the front, and a hub part that is provided inside the cup part and that has an opposing surface that forms a gap part with said extended paint surface throughout the entire circumference,
and said paint micronization means is said gap part for which the gap dimension between said extended paint surface and said opposing surface has been set to be less than 0.2 mm.

4. The coating machine described in claim 1, wherein said paint micronization means is a mesh-shaped micronization member that has a pore size of 20 μm or less and that has been provided in the paint supply channel.
